(19) United States
(12) Patent Application Publication
(10) Pub. No.: US 2023/0399028 A1
(43) Pub. Date: Dec. 14, 2023

(54) VEHICLE CONTROL DEVICE, VEHICLE CONTROL METHOD, AND PROGRAM

(71) Applicant: HONDA MOTOR CO., LTD., Minato-ku, Tokyo (JP)

(72) Inventors: Tomoaki Yamabe, Wako-shi (JP); Daichi Kato, Wako-shi (JP); Nozomu Hirosawa, Wako-shi (JP)

(21) Appl. No.: 17/912,874

(22) PCT Filed: Dec. 10, 2020
(86) PCT No.: PCT/JP2020/046051

§ 371 Date: Sep. 20, 2022

(51) Int. Cl. B60W 60/00; B60W 30/182

(52) U.S. Cl. CPC B60W 60/005; B60W 30/182; B60W 2555/00

(57) ABSTRACT

A vehicle control device includes a recognizer configured to recognize a surrounding situation of a vehicle, a driving controller configured to control steering and acceleration or deceleration of the vehicle without depending on an operation of a driver of the vehicle, and a mode determiner configured to determine a driving mode of the vehicle to be one of a plurality of driving modes including a first driving mode and a second driving mode, in which it is recognized that there is an end point to end the second driving mode due to a road structure on a traveling direction side of the vehicle, and the driving mode of the vehicle is changed from the second driving mode to the first driving mode when a distance from the end point is equal to or less than a reference distance.

### TECHNICAL FIELD

The present invention relates to a vehicle control device, a vehicle control method, and a program.

### BACKGROUND ART

Conventionally, the invention of an in-vehicle system is disclosed, which includes a storage determination processor that repeatedly determines the presence or absence of high-precision map information for a road on which a host vehicle has passed, a storage information acquisition processor that acquires information indicating a result of the repeated determination, and an automated driving possibility notifier that notifies the information acquired by the storage information acquisition processor (Patent Document 1).

### CITATION LIST

### Patent Literature

[Patent Literature 1]
Japanese Unexamined Patent Application, First Publication No. 2018-189594

### SUMMARY OF INVENTION

### Technical Problem

In the conventional technology, information stored in a map is used to mechanically notify of the possibility of automated driving, but an actual traffic situation is more complicated and it may not be possible to perform appropriate control according to a road structure in some cases.

The present invention has been made in consideration of such circumstances, and one of the objects of the present invention is to provide a vehicle control device, a vehicle control method, and a program capable of performing appropriate control according to a road structure.

### Solution to Problem

The vehicle control device according to the present invention has adopted the following configuration.
(1): A vehicle control device according to one aspect of the present invention includes a recognizer configured to recognize a surrounding situation of a vehicle, a driving controller configured to control steering and acceleration or deceleration of the vehicle without depending on an operation of a driver of the vehicle, and a mode determiner configured to determine a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode is controlled by the driving controller, and to change the driving mode of the vehicle to a driving mode in which the task is heavier when a task according to the determined driving mode is not executed by the driver, in which the recognizer recognizes that there is an end point to end the second driving mode due to a road structure on a traveling direction side of the vehicle, and the mode determiner changes the driving mode of the vehicle from the second driving mode to the first driving mode when a distance between the vehicle and the end point is equal to or less than a reference distance.
(2): In the aspect of (1) described above, the second driving mode is a driving mode in which a task of gripping an operator that receives a steering operation is not imposed on the driver, and the first driving mode is a driving mode in which the driver is required to perform a driving operation for at least one of steering and acceleration or deceleration of the vehicle.
(3): In the aspect of (1) described above, the second driving mode is a driving mode in which a task of gripping an operator that receives a steering operation is not imposed on the driver, and the first driving mode is a driving mode in which at least the task of gripping the operator that receives a steering operation is imposed on the driver.
(4) In the aspect of (1) described above, the mode determiner changes the reference distance on the basis of a speed of the vehicle.
(5) In the aspect of (1) described above, the end point is a point at which the vehicle enters a branch road from a main line, and the mode determiner changes the reference distance on the basis of the number of lane changes required for the vehicle to reach a lane closest to the branch road.
(6): In the aspect of (1) described above, the end point is a point at which the vehicle enters the branch road from the main line, and the mode determiner changes the reference distance on the basis of the speed of the vehicle and the number of lane changes required for the vehicle to reach a lane closest to the branch road.
(7): In the aspect of (1) described above, the end point is a point at which the vehicle enters the branch road from the main line to travel along a road to a destination set on a system
(8): In the aspect of (1) described above, the end point is at least one end of a prohibited section set as a section in which the second driving mode is prohibited, and the mode determiner changes the driving mode of the vehicle from the second driving mode to the first driving mode, and then changes the driving mode of the vehicle to the second driving mode on condition that the vehicle has passed the prohibited section.
(9): In the aspect of (8) described above, the mode determiner changes the driving mode of the vehicle from the second driving mode to the first driving mode, and then travels a predetermined distance after the vehicle passes through the prohibited section or changes the driving mode of the vehicle to the second driving mode after a predetermined time has elapsed.
(10): A vehicle control method according to another aspect of the present invention includes, by a computer installed in a vehicle, recognizing a surrounding situation of the vehicle, controlling steering and acceleration or deceleration of the vehicle without depending on an operation of a driver of the vehicle, determining a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode are performed by controlling steering and acceleration or deceleration of the vehicle without depending on an operation of a driver of the vehicle, changing the driving mode of the vehicle to a driving mode in which the task is heavier when a task according to the determined driving mode is not executed by the driver, recognizing that there is an end point to end the second driving mode due to a road structure on a traveling direction side of the vehicle when recognizing the surrounding situation of the vehicle, and changing the driving mode of the vehicle from the second driving mode to the first driving mode when a distance between the vehicle and the end point is equal to or less than a reference distance.
(11): A program according to still another aspect of the present invention causes a computer installed in a vehicle to execute recognizing a surrounding situation of the vehicle, controlling steering and acceleration or deceleration of the vehicle without depending on an operation of a driver of the vehicle, determining a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode are performed by controlling steering and acceleration or deceleration of the vehicle without depending on an operation of a driver of the vehicle, changing the driving mode of the vehicle to a driving mode in which the task is heavier when a task according to the determined driving mode is not executed by the driver, recognizing that there is an end point to end the second driving mode due to a road structure on a traveling direction side of the vehicle when recognizing the surrounding situation of the vehicle, and changing the driving mode of the vehicle from the second driving mode to the first driving mode when a distance between the vehicle and the end point is equal to or less than a reference distance.

### Advantageous Effects of Invention

According to the aspects of (1) to (11) described above, it is possible to perform appropriate control according to a road structure.

### BRIEF DESCRIPTION OF DRAWINGS

FIG. 1 is a configuration diagram of a vehicle system using a vehicle control device according to an embodiment.

FIG. 2 is a functional configuration diagram of a first controller and a second controller.

FIG. 3 is a diagram which shows an example of a corresponding relationship between a driving mode, a control state of a host vehicle, and a task.

FIG. 4 is a diagram for describing control when a prohibited section is passed through.

FIG. 5 is a diagram which shows an example of a relationship between a speed and the number of times when a mode determiner determines a reference distance.

FIG. 6 is a diagram which shows an example of another situation in which a driving mode is changed.

FIG. 7 is a flowchart which shows an example of a flow of processing executed by a recognizer and the mode determiner.

### DESCRIPTION OF EMBODIMENTS

Hereinafter, embodiments of a vehicle control device, a vehicle control method, and a program of the present invention will be described with reference to the drawings.

[Overall Configuration]

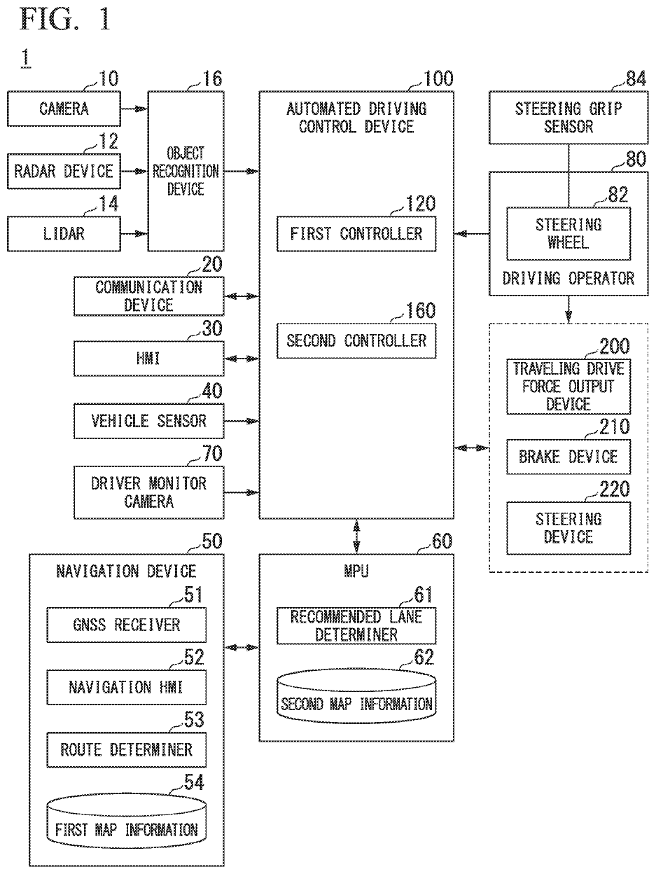

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle system 1 includes, for example, a camera 10, a radar device 12, a light detection and ranging (LIDAR) 14, an object recognition device 16, a communication device 20, a human machine interface (HMI) 30, and a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is a digital camera that uses a solid-state image sensor such as a charge coupled device (CCD) or a complementary metal oxide semiconductor (CMOS). The camera 10 is attached to an arbitrary place in a vehicle in which the vehicle system 1 is mounted (hereinafter, referred to as a host vehicle M). When an image of the front is captured, the camera 10 is attached to an upper part of the front windshield, a back surface of the windshield rear-view mirror, and the like. The camera 10 periodically and repeatedly captures, for example, an image of a periphery of the host vehicle M. The camera 10 may be a stereo camera.

The radar device 12 radiates radio waves such as millimeter waves to the vicinity of the host vehicle M, and detects radio waves (reflected waves) reflected by an object to detect at least the position (distance and orientation) of the object. The radar device 12 is attached to an arbitrary place of the host vehicle M. The radar device 12 may detect the position and speed of the object by a frequency modulated continuous wave (FM-CW) method.

The LIDAR 14 irradiates the vicinity of the host vehicle M with light (or an electromagnetic wave having a wavelength close to that of light) and measures scattered light. The LIDAR 14 detects a distance to a target on the basis of a time from light emission to light reception. The emitted light is, for example, a pulsed laser beam. The LIDAR 14 is attached to arbitrary place of the host vehicle M.

The object recognition device 16 performs sensor fusion processing on results of detection by some or all of the camera 10, the radar device 12, and the LIDAR 14, and recognizes the position, type, speed, and the like of the object. The object recognition device 16 outputs a result of the recognition to the automated driving control device 100. The object recognition device 16 may output the results of the detection by the camera the radar device 12, and the LIDAR 14 to the automated driving control device 100 as they are. The object recognition device 16 may be omitted from the vehicle system 1.

The communication device 20 communicates with another vehicle present in the vicinity of the host vehicle M by using, for example, a cellular network, a Wi-Fi network, Bluetooth (registered trademark), dedicated short range communication (DSRC), or the like, and communicates with various server devices via a wireless base station.

The HMI 30 presents various types of information to an occupant of the host vehicle M and receives an input operation by the occupant. The HMI 30 includes various display devices, speakers, buzzers, touch panels, switches, keys, and the like.

The vehicle sensor 40 includes a vehicle speed sensor that detects a speed of the host vehicle M, an acceleration sensor that detects an acceleration, a yaw rate sensor that detects an angular speed around the vertical axis, an orientation sensor that detects a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M based on a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the host vehicle M can travel on a reasonable route to proceed to the branch destination.

The second map information 62 is map information with higher accuracy than the first map information 54. The second map information 62 includes, for example, information on a center of a lane, information on a boundary of the lane, and the like. In addition, the second map information 62 may include road information, traffic regulation information, address information (addresses/zip codes), facility information, telephone number information, information on prohibited sections where a mode A or a mode B, which will be described below, is prohibited, and the like. The second map information 62 may be updated at any time by the communication device 20 communicating with another device.

The driver monitor camera 70 is, for example, a digital camera using a solid-state image sensor such as a CCD or CMOS. The driver monitor camera 70 is attached to any place in the host vehicle M, which is a position and orientation that allows the head of an occupant (hereinafter referred to as a driver) seated in the driver's seat of the host vehicle M to be imaged from the front (in a direction in which the face is imaged). For example, the driver monitor camera 70 is attached to an upper part of a display device provided in a center of an instrument panel of the host vehicle M.

The driving operator 80 includes, for example, besides the steering wheel 82, an accelerator pedal, a brake pedal, a shift lever, and other operators. The driving operator has a sensor that detects the amount of operation or a presence or absence of an operation attached thereto, and a result of detection is output to the automated driving control device 100, or some or all of the traveling drive force output device 200, the brake device 210, and the steering device 220. The steering wheel 82 is an example of “an operator that receives a steering operation by the driver.” The operator does not necessarily have to be circular, and may be in the form of a deformed steering, a joystick, a button, or the like. A steering grip sensor 84 is attached to the steering wheel 82. The steering grip sensor 84 is realized by a capacitance sensor or the like, and outputs a signal that can detect whether the driver is gripping the steering wheel 82 (meaning that the driver is in contact with the steering wheel 82 by applying force) to the automated driving control device 100.

The automated driving control device 100 includes, for example, a first controller 120, and a second controller 160. The first controller 120 and the second controller 160 are realized by, for example, a hardware processor such as a central processing unit (CPU) executing a program (software), respectively. In addition, some or all of these components may be realized by hardware (a circuit unit; including circuitry) such as large-scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the automated driving control device 100, or may be stored in a detachable storage medium such as a DVD or a CD-ROM and installed in the HDD or flash memory of the automated driving control device 100 by the storage medium (non-transitory storage medium) being attached to a drive device. The automated driving control device 100 is an example of a “vehicle control device,” and a combination of the action plan generator 140 and the second controller 160 is an example of a “driving controller.”

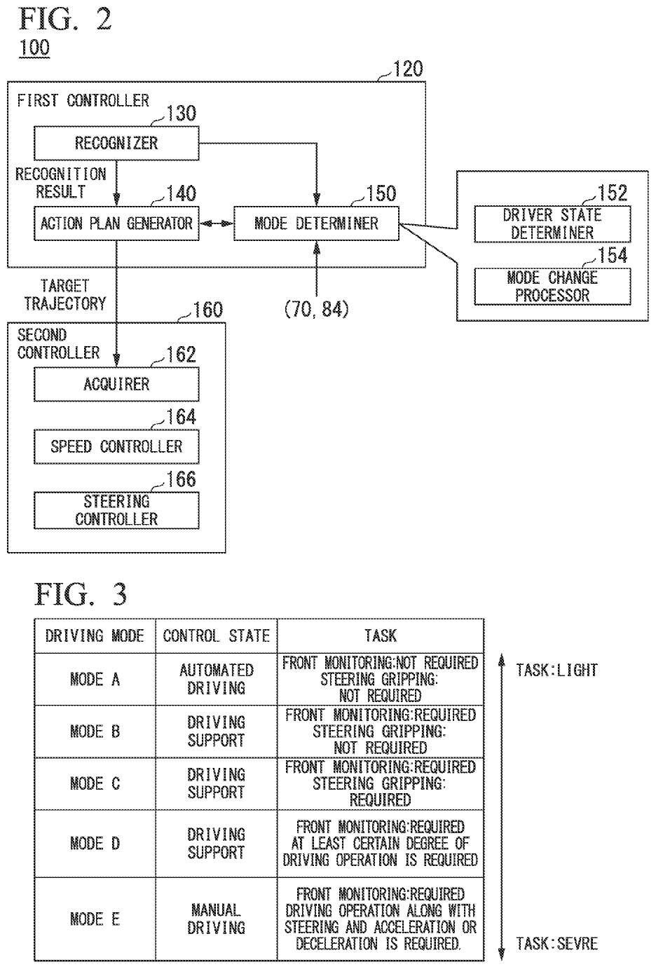

FIG. 2 is a functional configuration diagram of the first controller 120 and the second controller 160. The first controller 120 includes, for example, a recognizer 130, an action plan generator 140, and a mode determiner 150. The first controller 120 realizes, for example, a function by artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating the both. As a result, reliability of automated driving is ensured.

The recognizer 130 recognizes the position of an object in the vicinity of the host vehicle M and the state such as the speed and the acceleration on the basis of information input from the camera 10, the radar device 12, and the LIDAR 14 via the object recognition device 16. The position of an object is recognized as, for example, a position on absolute coordinates with a representative point (a center of gravity, a center of a drive axis, or the like) of the host vehicle M as an origin, and is used for control. The position of an object may be represented by a representative point such as the center of gravity or a corner of the object, or may be represented by a region. The “state” of an object may include the acceleration or jerk of the object, or the “behavioral state” (for example, whether the vehicle is changing lanes or intends to change lanes).

In addition, the recognizer 130 recognizes, for example, a lane (a traveling lane) in which the host vehicle M is traveling. For example, the recognizer 130 recognizes the traveling lane by comparing a pattern of road lane markings obtained from the second map information 62 (for example, an array of solid lines and broken lines) with a pattern of road lane markings in the vicinity of the host vehicle M recognized from an image captured by the camera 10. The recognizer 130 may recognize the traveling lane by recognizing not only the road lane markings but also traveling road boundaries (road boundaries) including road lane markings, a shoulder, a curb, a median strip, a guardrail, and the like. In this recognition, the position of the host vehicle M acquired from the navigation device 50 and a result of processing by INS may also be added. The recognizer 130 also recognizes stop lines, obstacles, red lights, tollhouses, and other road events.

The recognizer 130 recognizes the position and posture of the host vehicle M with respect to the traveling lane when the traveling lane is recognized. The recognizer 130 recognizes, for example, a deviation of the reference point of the host vehicle M from the center of the lane and an angle formed with respect to a line connecting the centers of the lane in the traveling direction of the host vehicle M as a relative position and a posture of the host vehicle M with respect to the traveling lane. Instead, the recognizer 130 may recognize a position of the reference point of the host vehicle M with respect to any side end (a road lane marking or a road boundary) of the traveling lane as the relative position of the host vehicle M with respect to the traveling lane.

The action plan generator 140 generates a target trajectory in which the host vehicle M automatically (regardless of an operation by the driver) travels in the future such that, in principle, the vehicle M travels on a recommended lane determined by the recommended lane determiner 61, and it may respond to a surrounding situation of the host vehicle M. The target trajectory contains, for example, a speed element. For example, the target trajectory is expressed as a sequence of points (trajectory points) to be reached by the host vehicle M. The trajectory point is a point to be reached by the host vehicle M for each predetermined traveling distance (for example, about several [m]) along the road, and separately, the target speed and the target acceleration are generated as parts of the target trajectory for a predetermined sampling time (for example, about decimal number [sec]). In addition, the trajectory point may be a position to be reached by the host vehicle M at a corresponding time for each predetermined sampling time. In this case, information of the target speed and the target acceleration is expressed by an interval of trajectory points.

The action plan generator 140 may set an event of automated driving when a target trajectory is generated. The event of automated driving includes a constant-speed traveling event, a low-speed following traveling event, a lane change event, a branching event, a merging event, a takeover event, and the like. The action plan generator 140 generates a target trajectory according to an event to be started.

The mode determiner 150 determines a driving mode of the host vehicle M to be one of a plurality of driving modes in which tasks imposed on the driver are different. The mode determiner 150 includes, for example, a driver state determiner 152 and a mode change processor 154. These individual functions will be described below.

FIG. 3 is a diagram which shows an example of driving modes, a control state of the host vehicle M, and a corresponding relationship of tasks. The driving modes of the host vehicle M include, for example, five modes from a mode A to a mode E. The degree of automation of the control state, that is, a driving control of the host vehicle M, is highest in the mode A, decreases in order of the mode B, the mode C, and the mode D, and the mode E is the lowest. On the other hand, the task imposed on the driver is the lightest in the mode A, becomes heavier in order of the mode B, the mode C, and the mode D, and the mode E is the heaviest. Since the control state is not automated driving in the modes D and E, it is the responsibility of the automated driving control device 100 to end control related to automated driving and shift to driving support or manual driving. Content of each driving mode will be exemplified below. Note that the mode A and/or the mode B is an example of a “first driving mode,” and the mode D and/or the mode E is an example of a “second driving mode.”

In the mode A, the vehicle is in the automated driving state, and neither forward monitoring nor gripping of steering wheel 82 (steering grip in FIG. 3) is imposed on the driver. However, even in the mode A, the driver is required to be in a position to quickly shift to manual driving in response to a request from a system mainly using the automated driving control device 100. Note that automated driving herein means that both steering and acceleration/deceleration are controlled without depending on the operation of the driver. The front is a space in the traveling direction of the host vehicle M that is visually recognized through the front windshield. The mode A is a driving mode that can be executed when a condition, such as that the host vehicle M is traveling at a predetermined speed (for example, about 50 [km/h]) or less on a motorway such as an expressway, and there is a preceding vehicle to be followed, is satisfied, and may be referred to as a traffic jam pilot (TJP) in some cases. When this condition is no longer satisfied, the mode determiner 150 changes the driving mode of the host vehicle M to the mode B.

In the mode B, the vehicle is in a state of driving support, and a task of monitoring the front of the host vehicle M (hereinafter referred to as forward monitoring) is imposed on the driver, but a task of gripping the steering wheel 82 is not. In the mode C, the vehicle is in the state of driving support, and the task of forward monitoring and the task of gripping the steering wheel 82 are imposed on the driver. The mode D is a driving mode in which the driver is required to perform a certain amount of driving operation for at least one of the steering and acceleration/deceleration of the host vehicle M. For example, driving support such as adaptive cruise control (ACC) or lane keeping assist system (LKAS) is performed in the mode D. In the mode E, the vehicle is in a state of manual driving, in which the driver is required to perform a driving operation for both steering and acceleration/deceleration. In both of the mode D and mode E, the task of monitoring the front of the host vehicle M is naturally imposed on the driver.

The automated driving control device 100 (and a driving support device (not shown)) executes an automatic lane change according to a driving mode. There are two types of automatic lane change: an automatic lane change (1) by a system request and an automatic lane change (2) by a driver request. The automatic lane change (1) includes an automatic lane change for passing performed when the speed of a preceding vehicle is lower than the speed of the host vehicle by a reference or more, and an automatic lane change for traveling to a destination (an automatic lane change due to a recommended lane being changed). In the automatic lane change (2), when conditions related to the speed and the positional relationship of a vehicle with surrounding vehicles are satisfied, and a direction indicator is operated by the driver, the host vehicle M is caused to change lanes in an operation direction.

The automated driving control device 100 does not execute either of the automatic lane changes (1) and (2) in the mode A. The automated driving control device 100 executes any one of the automatic lane changes (1) and (2) in the modes B and C. The driving support device (not shown) does not execute the automatic lane change (1) but executes the automatic lane change (2) in the mode D. In the mode E, neither of the automatic lane changes (1) and (2) is executed.

The mode determiner 150 changes the driving mode of the host vehicle M to a driving mode in which the task is heavier when a task related to a determined driving mode (hereinafter referred to as a current driving mode) is not executed by the driver.

For example, in the mode A, when the driver is in a position where he/she cannot shift to manual driving in response to a request from the system (for example, when he/she continues to look aside outside a permissible area or when a sign of difficulty in driving is detected), the mode determiner 150 performs control such as prompting a shift to manual driving using the HMI 30, causing the host vehicle M to move to the shoulder of a road and to gradually stop if the driver does not respond, and stopping automated driving. After the automated driving is stopped, the host vehicle is in a state of the mode D or E, and the host vehicle M can be started by a manual operation of the driver. In the following description, the same applies to “stopping automated driving.” If the driver is not monitoring the front in the mode B, the mode determiner 150 performs control such as prompting the driver to monitor the front using the HMI 30, causing the host vehicle M to move to the shoulder of the road and to gradually stop if the driver does not respond, and stopping automated driving. When the driver is not monitoring the front in the mode C, or when the driver is not gripping the steering wheel 82, the mode determiner 150 performs control such as prompting the driver to perform forward monitoring and/or to grip the steering wheel 82 using the HMI causing the host vehicle M to move to the shoulder of the road and to gradually stop if the driver does not respond, and stopping the automated driving.

The driver state determiner 152 monitors the state of a driver for the mode change described above and determines whether the state of a driver is a state corresponding to a task. For example, the driver state determiner 152 analyzes an image captured by the driver monitor camera 70 to perform posture estimation processing, and determines whether the driver is in a position where he/she cannot shift to manual driving in response to a request from the system. Moreover, the driver state determiner 152 analyzes the image captured by the driver monitor camera 70 to perform eye-gaze estimation processing, and determines whether the driver is monitoring the front.

The mode change processor 154 performs various types of processing for mode change. For example, the mode change processor 154 instructs the action plan generator 140 to generate a target trajectory for shoulder stop, instructs the driving support device (not shown) to operate, or controls the HMI 30 to prompt the driver to take action.

The second controller 160 controls the traveling drive force output device 200, the brake device 210, and the steering device 220 so that the host vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information on a target trajectory (trajectory points) generated by the action plan generator 140 and stores it in a memory (not shown). The speed controller 164 controls the traveling drive force output device 200 or the brake device 210 based on a speed element associated with the target trajectory stored in the memory. The steering controller 166 controls the steering device 220 according to a degree of bending of the target trajectory stored in the memory. Processing of the speed controller 164 and the steering controller 166 is realized by, for example, a combination of feedforward control and feedback control. As an example, the steering controller 166 executes feedforward control according to a curvature of a road in front of the host vehicle M and feedback control based on a deviation from the target trajectory in combination.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and an electronic control unit (ECU) that controls these. The ECU controls the configuration described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor according to the information input from the second controller 160 or the information input from the driving operator 80 so that a brake torque according to a braking operation is output to each wheel. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to the information input from the second controller 160 to transmit the hydraulic pressure of the master cylinder to the cylinder.

The steering device 220 includes, for example, a steering ECU and an electric motor. The electric motor changes, for example, a direction of a steering wheel by applying a force to a rack and pinion mechanism. The steering ECU drives the electric motor according to the information input from the second controller 160 or the information input from the driving operator 80, and changes the direction of the steering wheel.

[Control According to Prohibited Section and End Point]

Hereinafter, content of control regarding the end of the mode A or B according to a prohibited section and an end point will be described. The recognizer 130 recognizes that there is an end point on the traveling direction side of the host vehicle to end the mode A or B due to a road structure. The end point is, for example, an end of a prohibited section that the host vehicle M first passes through when the host vehicle M passes through the prohibited section in which the execution of the mode A or B is prohibited. The recognizer 130 recognizes that the host vehicle M passes through the prohibited section, for example, when a recommended lane determined by the MPU 60 is set in the prohibited section.

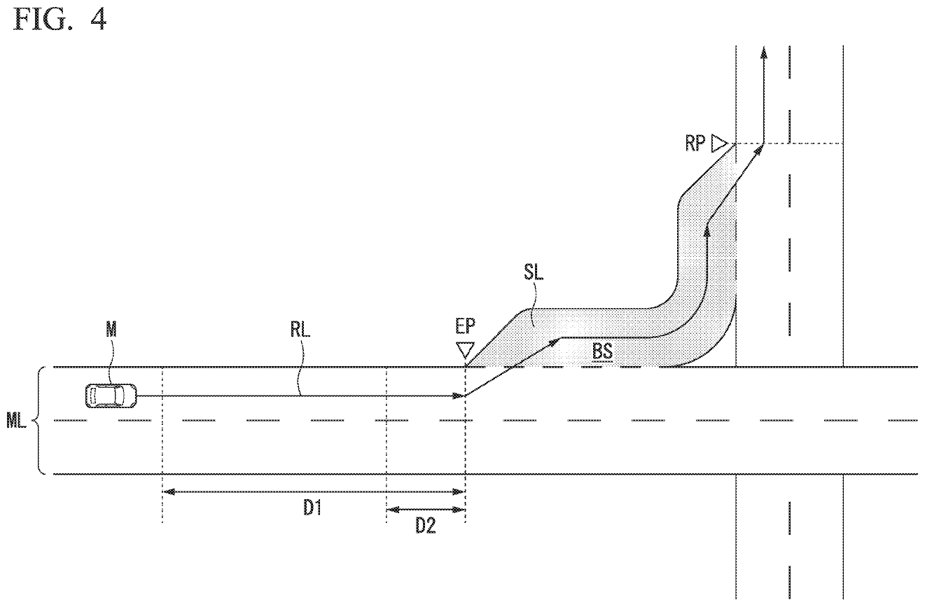

FIG. 4 is a diagram for describing control when the host vehicle M passes through the prohibited section. In the situation of FIG. 4, the host vehicle M is traveling on a main line ML, and a route on a map to proceed to another main line via a branch road SL to reach a destination is determined. The MPU 60 sets a recommended lane on the basis of the route on a map. In FIG. 4, an arrow RL indicates a guidance route connecting recommended lanes. EP is an end point, BS is a prohibited section, and RP is a restartable point. When a recommended lane is generated, the MPU 60 acquires a prohibited section BS present on the guidance path RL from the second map information 62, specifies both ends thereof as the end point EP and the restartable point RP, and outputs information that identifies the position or area of the prohibited section BS, the end point EP, and the restartable point RP to the recognizer 130. The recognizer 130 recognizes the information of these points and sections on the basis of the information acquired from the MPU 60.

The recognizer 130 first recognizes that the host vehicle M should enter a branch road on the basis of the recommended route acquired from the MPU 60. Further, when the recognizer 130 has recognized that a distance between the host vehicle M and the end point EP is equal to or less than an event start distance D1 on the basis of the position of the host vehicle M and the position of the end point EP, the recognizer 130 notifies the action plan generator 140 of that fact. The event start distance D1 is, for example, a distance of about several [km]. The action plan generator 140 activates a branch event in response to the notification from the recognizer 130. The action plan generator 140 generates a target trajectory so that lane change is completed in a lane closest to the branch road SL by the end point EP.

When the recognizer 130 has recognized that the distance between the host vehicle M and the end point EP is equal to or less than a reference distance D2 on the basis of the position of the host vehicle M and the position of the end point EP, the recognizer 130 notifies the mode determiner 150 of that fact. The mode determiner 150 changes the driving mode to the mode D or E when the driving mode at that time is the mode A or B in response to the notification from the recognizer 130. As a result, the driver can prepare to enter (change lanes) the branch road SL in the driving support state in the mode D or manual driving until the host vehicle M reaches the end point EP, and start the driving operation with a margin compared to a case in which the mode A or B suddenly ends at the end point EP. The mode C may be inserted while the driving mode is changed from the mode A or B to the mode D or E. In this case, when the driver does not grip the steering wheel 82 during a period of the mode C, the action plan generator 140 may temporarily stops the vehicle on the shoulder of a road, or the like, and then changes the driving mode to the mode D or E. In addition, the driving mode may be changed from the mode A or B to the mode C instead of changing the driving mode from the mode A or B to the mode D or E.

[About Reference Distance]

The reference distance D2 may be a fixed value, or the mode determiner 150 may dynamically determine the reference distance D2 on the basis of one or both of the speed V_{M} of the host vehicle M and the number of lane changes Nc required to reach the end point EP. The recognizer 130 may have a function of determining the reference distance.

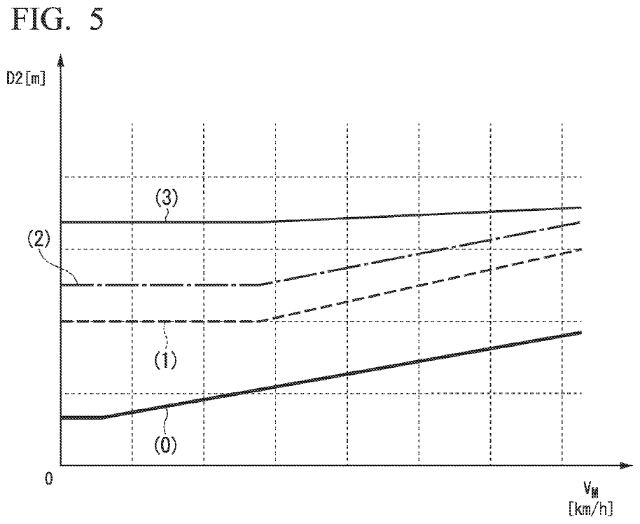

FIG. 5 is a diagram which shows an example of a relationship between the speed V_{M} and the number of lane changes Nc when the mode determiner 150 determines the reference distance D2. In FIG. 5, (0) exemplifies a relationship when the number of lane changes Nc required to reach the end point EP is zero, (1) exemplifies the relationship when the number of lane changes Nc is one time, (2) exemplifies the relationship when the number of lane changes Nc is 2 times, and (3) exemplifies the relationship when the number of lane changes Nc is 3 times or more. The mode determiner 150 increases the reference distance D2 as the speed V_{M} increases. In addition, the mode determiner 150 increases the reference distance D2 as the number of lane changes Nc increases. The mode determiner 150 may determine the reference distance D2 on the basis of only one of the speed V_{M} and the number of lane changes Nc. As mentioned above, the action plan generator 140 generates a target trajectory so that the lane change is completed in a lane closest to the branch road SL by the end point EP, so a situation where the number of lane changes Nc is 1 or more times is usually unlikely to occur, but a lane change by the action plan generator 140 may not proceed smoothly due to traffic conditions such as traffic jams, and a situation may occur in which the lane change is necessary even though the end point EP is approached. In such a case, it is often smoother to change a lane to a side of the branch road SL by manual driving, so the reference distance D2 is increased to finish automated driving earlier.

[Resume Mode A or B]

The mode determiner 150 may also change the driving mode to the mode A or B on condition that the vehicle M passes through a prohibited section after changing the mode A or B to the mode D or E because the distance between the host vehicle M and the end point EP is equal to or less than the reference distance D2. This can improve convenience. The mode determiner 150 may request an operation of the driver for the HMI 30 as a condition for changing the driving mode to the mode A or B. More specifically, the mode determiner 150 may change the driving mode to the mode A or B after the host vehicle has traveled a predetermined distance or after a predetermined time has elapsed from the passage of the prohibited section BS. By doing so, since the driving mode is changed after a traffic phase becomes stable, it is possible to suppress a disturbance of control due to the switching of the driving mode.

[About Other Situations]

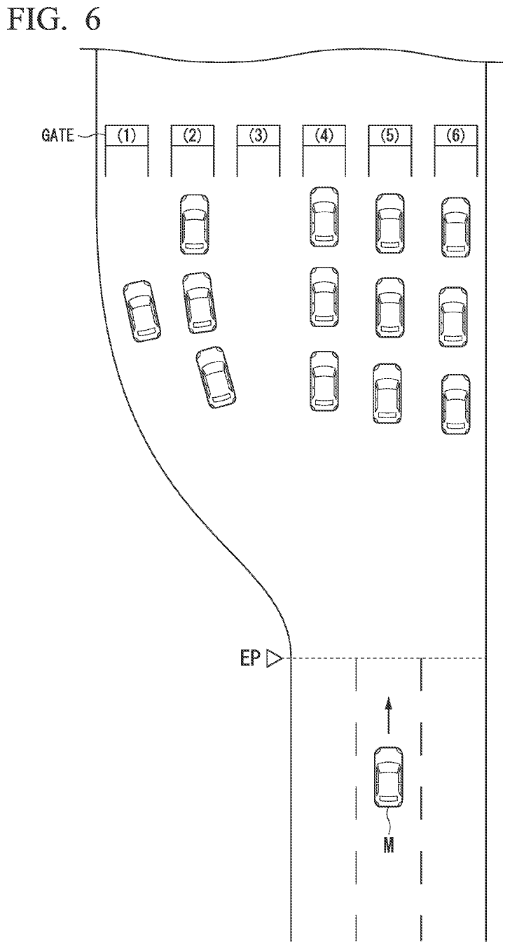

The mode determiner 150 may perform control of changing the driving mode on the basis of the end point EP not only in the “situation in which the vehicle enters a branch road from a main line to travel to a destination” described above, but also in other situations as well. For example, the end point EP may be a point where road lane markings (white lines) disappear in front of a tollhouse provided at the end of an expressway. FIG. 6 is a diagram which shows an example of another situation in which the driving mode is changed. In the shown example, the host vehicle M is heading toward a tollhouse provided with a plurality of gates, and since the number of gates is more than the number of lanes, the road lane markings disappear at the end point EP, which is a starting point of a widening section. The information of this end point EP is stored in the second map information 62, and the MPU 60 notifies the recognizer 130 of the presence of the end point EP on the traveling direction side of the host vehicle M. The prohibited section BS in this situation extends toward the other side of the tollhouse, and control regarding a restart of the mode A or B does not have to be performed. The recognizer 130 recognizes the presence of the end point EP, and, when the distance between the host vehicle M and the end point EP is equal to or less than the reference distance D2, the recognizer 130 notifies the mode determiner 150 of that fact. Subsequent processing is the same as in the situation shown in FIG. 4.

[Processing Flow]

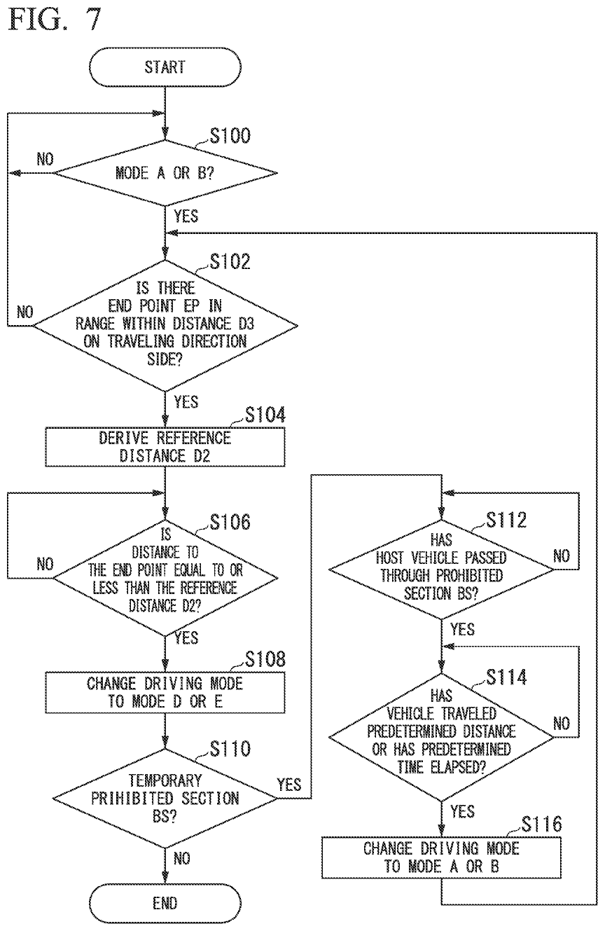

FIG. 7 is a flowchart which shows an example of a flow of processing executed by the recognizer 130 and the mode determiner 150. The processing of this flowchart is started, for example, when automated driving is started.

First, the mode determiner 150 determines whether the current driving mode of the host vehicle M is the mode A or B (step S100). When the current driving mode of the host vehicle M is neither the mode A nor B, the mode determiner 150 repeatedly performs the determination in step S100.

When it is determined that the current driving mode of the host vehicle M is the mode A or B, the recognizer 130 determines whether there is the end point EP in a range within a distance D3 on the traveling direction side of the host vehicle M (step S102). The distance D3 is, for example, a distance equal to or longer than the event start distance D1. When it is determined that there is no end point EP in the range within the distance D3 on the traveling direction side of the host vehicle M, the processing returns to step S100.

When it is determined that there is the end point EP in the range within the distance D3 on the traveling direction side of the host vehicle M, the mode determiner 150 derives the reference distance D2 in the method described above (step S104). Then, the recognizer 130 determines whether a distance from the host vehicle M to the end point is equal to or less than the reference distance D2 (step S106). When it is determined that the distance from the host vehicle M to the end point exceeds the reference distance D2, the recognizer 130 repeatedly performs the determination in the step S106. When it is determined that the distance from the host vehicle M to the end point is equal to or less than the reference distance D2, the mode determiner 150 changes the driving mode of the host vehicle M to the mode D or E (step S108).

Next, the recognizer 130 determines whether the prohibited section BS corresponding to the end point EP to be passed this time is a temporary prohibited section BS (step S110). Temporary prohibited section BS refers to a section that can be passed within a few minutes, and a road that enables automated driving is connected to the end. When it is determined that it is not the temporary prohibited section BS, the processing of this flowchart ends.

When it is determined that it is the temporary prohibited section BS, the mode determiner 150 determines whether the host vehicle M has passed through the prohibited section BS (step S112). When it is determined that the vehicle has passed through the prohibited section BS, it is determined whether the vehicle has traveled a predetermined distance from the passing point or whether a predetermined time has elapsed from the passing time (step S114). When a positive determination is made in both steps S112 and S114, the mode determiner 150 changes the driving mode of the host vehicle M to the mode A or B (step S116), and returns the processing to step S102.

By performing the processing described above, the driver can prepare to shift to manual driving by the time the host vehicle M reaches the end point EP, and start the driving operation with a margin compared to a case in which the mode A or B suddenly ends at the end point EP. Therefore, it is possible to perform appropriate control according to a road structure.

The embodiments described above can be expressed as follows.

A vehicle control device includes a storage device that has stored a program, and a hardware processor, in which the hardware processor executes the program, thereby recognizing the surrounding situation of a vehicle, controlling steering and acceleration or deceleration of the vehicle without depending on an operation of a driver of the vehicle, determining a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode is controlled by the driving controller, changing the driving mode of the vehicle to a driving mode in which the task is heavier when a task according to the determined driving mode is not executed by the driver, recognizing that there is an end point to end the second driving mode due to a road structure on a traveling direction side of the vehicle at the time of the recognition, and changing the driving mode of the vehicle from the second driving mode to the first driving mode when a distance between the vehicle and the end point is equal to or less than a reference distance.

Although a mode for carrying out the present invention has been described above using the embodiment, the present invention is not limited to the embodiment, and various modifications and substitutions can be made within a range not departing from the gist of the present invention.

### REFERENCE SIGNS LIST

10 Camera
12 Radar device
14 LIDAR
16 Object recognition device
70 Driver monitor camera
82 Steering wheel
84 Steering grip sensor
100 Automated driving control device
130 Recognizer
140 Action plan generator
150 Mode determiner
152 Driver state determiner
154 Mode change processor

What is claim is:

1-11. (canceled)

12. A vehicle control device comprising:
a recognizer configured to recognize a surrounding situation of a vehicle;
a driving controller configured to control steering and acceleration or deceleration of the vehicle without depending on an operation of a driver of the vehicle; and
a mode determiner configured to determine a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode are controlled by the driving controller, and to change the driving mode of the vehicle to a driving mode in which the task is heavier when a task according to the determined driving mode is not executed by the driver,
wherein: the recognizer recognizes that there is an end point to end the second driving mode due to a road structure on a traveling direction side of the vehicle;
the mode determiner changes the driving mode of the vehicle from the second driving mode to the first driving mode when a distance between the vehicle and the end point is equal to or less than a reference distance;
the end point is a point at which the vehicle enters a branch road from a main line; and
the mode determiner changes the reference distance on the basis of the number of lane changes required for the vehicle to reach a lane closest to the branch road.

13. A vehicle control device comprising:
a recognizer configured to recognize a surrounding situation of a vehicle;
a driving controller configured to control steering and acceleration or deceleration of the vehicle without depending on an operation of a driver of the vehicle; and
a mode determiner configured to determine a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode are controlled by the driving controller, and to change the driving mode of the vehicle to a driving mode in which the task is heavier when a task according to the determined driving mode is not executed by the driver,
wherein: the recognizer recognizes that there is an end point to end the second driving mode due to a road structure on a traveling direction side of the vehicle;
the mode determiner changes the driving mode of the vehicle from the second driving mode to the first driving mode when a distance between the vehicle and the end point is equal to or less than a reference distance;
the end point is a point at which the vehicle enters the branch road from the main line; and
the mode determiner changes the reference distance on the basis of the speed of the vehicle and the number of lane changes required for the vehicle to reach a lane closest to the branch road.

14. The vehicle control device according to claim 12,
wherein the second driving mode is a driving mode in which a task of gripping an operator that receives a steering operation is not imposed on the driver, and
the first driving mode is a driving mode in which the driver is required to perform a driving operation for at last one of steering and acceleration or deceleration of the vehicle.

15. The vehicle control device according to claim 12,
wherein the second driving mode is a driving mode in which a task of gripping an operator that receives a steering operation is not imposed on the driver, and
the first driving mode is a driving mode in which at least the task of gripping the operator that receives a steering operation is imposed on the driver.

16. The vehicle control device according to claim 12,
wherein the mode determiner changes the reference distance on the basis of a speed of the vehicle.

17. The vehicle control device according to claim 12,
wherein the end point is a point at which the vehicle enters the branch road from the main line to travel along a road to a destination set on a system.

18. The vehicle control device according to claim 12,
wherein the end point is at least one end of a prohibited section set as a section in which the second driving mode is prohibited, and
the mode determiner changes the driving mode of the vehicle from the second driving mode to the first driving mode, and then changes the driving mode of the vehicle to the second driving mode on condition that the vehicle has passed the prohibited section.

19. The vehicle control device according to claim 18,
wherein the mode determiner changes the driving mode of the vehicle from the second driving mode to the first driving mode, and then travels a predetermined distance after the vehicle passes through the prohibited section or changes the driving mode of the vehicle to the second driving mode after a predetermined time has elapsed.

20. A vehicle control method executed by a computer installed in a vehicle, the method comprising:
recognizing a surrounding situation of the vehicle;
controlling steering and acceleration or deceleration of the vehicle without depending on an operation of a driver of the vehicle;
determining a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode are performed by controlling steering and acceleration or deceleration of the vehicle without depending on an operation of a driver of the vehicle;
changing the driving mode of the vehicle to a driving mode in which the task is heavier when a task according to the determined driving mode is not executed by the driver;
recognizing that there is an end point to end the second driving mode due to a road structure on a traveling direction side of the vehicle when recognizing the surrounding situation of the vehicle; and
changing the driving mode of the vehicle from the second driving mode to the first driving mode when a distance between the vehicle and the end point is equal to or less than a reference distance,
wherein the end point is a point at which the vehicle enters a branch road from a main line, and
wherein the changing the driving mode includes changing the reference distance on the basis of the number of lane changes required for the vehicle to reach a lane closest to the branch road.

21. A vehicle control method executed by a computer installed in a vehicle, the method comprising:
recognizing a surrounding situation of the vehicle;
controlling steering and acceleration or deceleration of the vehicle without depending on an operation of a driver of the vehicle;
determining a driving mode of the vehicle to be one of a plurality of driving modes including a first driving mode and a second driving mode in which the second driving mode is a driving mode in which the task imposed on the driver is lighter than that in the first driving mode and at least some of the plurality of driving modes including the second driving mode are performed by controlling steering and acceleration or deceleration of the vehicle without depending on an operation of a driver of the vehicle;
changing the driving mode of the vehicle to a driving mode in which the task is heavier when a task according to the determined driving mode is not executed by the driver;
recognizing that there is an end point to end the second driving mode due to a road structure on a traveling direction side of the vehicle when recognizing the surrounding situation of the vehicle; and
changing the driving mode of the vehicle from the second driving mode to the first driving mode when a distance between the vehicle and the end point is equal to or less than a reference distance,
wherein the end point is a point at which the vehicle enters a branch road from a main line, and
wherein the changing the driving mode includes changing the reference distance on the basis of the speed of the vehicle and the number of lane changes required for the vehicle to reach a lane closest to the branch road.
